(19) United States
(12) Patent Application Publication
(10) Pub. No.: US 2002/0157098 A1
(43) Pub. Date: Oct. 24, 2002

(54) Electronic program guide including recordable virtual channels for interactive television

(75) Inventors: Frederick J. Zustak, Poway, CA (US); Hans Mahr, Escandido, CA (US)

Correspondence Address: John L. Rogitz, Suite 3120, 750 B Street, San Diego, CA, 92101, US

(73) Assignee: SONY CORPORATION, Toyko (JP)

(21) Appl. No.: 09/839,630

(22) Filed: Apr. 20, 2001

(51) Int. Cl. H04N 5/445; G06F 3/00; G06F 13/00

(52) U.S. Cl. 725/51; 725/48; 725/58; 725/38

(57) ABSTRACT

An electronic program guide including virtual channels for interactive television includes multiple television listings and multiple Web site listings, along with broadcast or availability times. Each television listing is linked to a respective television channel indicator, while each Web listing is linked to a respective virtual channel indicator. The user can record Web content onto the television or peripheral device by appropriately manipulating an electronic program guide displayed by the television.

### BACKGROUND OF THE INVENTION

1. Field of the Invention

The present invention relates generally to television systems.

2. Description of the Related Art

Televisions are ubiquitous, as are Internet computers. Currently, however, consumers typically purchase and use two separate systems to enjoy television and Internet access. Namely, consumers must purchase a television to watch television, and a computer to access the Internet. One result not only is that costs are duplicated and significant space is required, but also that undertaking both activities at once, in one room, can be difficult.

Moreover, the need for two systems burdens some consumers who, while familiar with operating a television and its remote control, might not be familiar with operating an Internet computer. Nonetheless, while perhaps not requiring comprehensive Internet support, such consumers can still benefit from advantages provided by simple, straightforward, intuitive Internet interaction. For example, many consumers might only desire easy access to a weather site or traffic site for obtaining up-to-date information before proceeding to work in the morning, without having to know a great deal about how to operate a Web browser. As recognized herein, it consequently would be advantageous to provide an Internet access appliance that is easy and intuitive to use, for instance one that could be used like a television remote control.

To the extent that attempts have been made to combine television with Internet features, the above-noted consumer needs have remained unfulfilled. For instance, in the system known as “WebTV”, preselected Internet pages are loaded once into a television appliance during manufacture and never subsequently updated, with the preselected pages being accessible through the television appliance using a computer keyboard with its attendant complexity. Since the pages are not updated, however, many Internet-related features such as up-to-date traffic, weather, and news, are not immediately available. Instead, the consumer must access a central site using one of the preselected pages, and then be redirected to a desired Web page. In terms of currently expected speeds of Internet access, this consumes an undue amount of time. Furthermore, it requires browser or browser-like operations that must be initiated by a consumer who might only wish to turn on the television and immediately access up-to-date information using the relatively simple TV remote control without further ado.

Still further, current systems provide the same preselected Web pages to all consumers. As understood herein, it would be advantageous to tailor, for each consumer, what Web pages are provided in a television to that particular consumer. In this way, a consumer is much more likely to gain useful and enjoyable Internet access than he or she would be able to gain otherwise.

Additionally, as mentioned above, in the above-mentioned Web TV system, a keyboard is required for user input to access Web sites. For television functions, however, consumers are accustomed to using a much simpler input device, namely, a remote control. Thus, existing systems that attempt to integrate television and Internet computers do not do so seamlessly, but rather require the operation of two separate systems that require two separate input devices. This complicates matters for the consumer, and is confusing. The object of the present invention is to address one or more of the above-noted consumer needs.

### SUMMARY OF THE INVENTION

A method includes providing an electronic program guide on an interactive television. The method also includes enabling a consumer to view a television channel and virtual channel listing using the electronic program guide, with the virtual channel being associated with at least one Web page. A user can access the program guide to record content that is associated with the virtual channel.

In another implementation, the user uses the virtual channel to request that an item of content listed on the virtual channel be recorded, either immediately or at a subsequent (e.g., broadcast) time. The content that might be listed and requested to be recorded includes audio (songs), video (game previews or movies), or content to be broadcast via the Web or via a televised broadcast at a later time. In the case where a virtual channel is associated with a television channel, and the virtual channel itself has an EPG, the EPG of the virtual channel can be used to request recordation of content by a user selecting an entry on the EPG. This creates the ability for the virtual channel owner/provider to promote its broadcast programming in a more direct way. Or, instead of an EPG the virtual channel may use only icons or text for featured programs, and these can be selected by a user to cause the associated content to be recorded. Still further, a page in a virtual channel for a broadcast program may include link/button/icon information, allowing a user to select that link/button/icon to request recording of the associated broadcast.

In one implementation a user request to record content associated with a virtual channel is received at the television. In another implementation, the request is received at a virtual channel Web site via the program guide.

The content can be recorded on a medium inside the television, or it can be recorded on a medium inside a peripheral device associated with the television. The user request selects a recording time listed on the program guide, or it can specify a recording time not listed on the program guide, or it can specify an immediate recording time.

In another aspect, an electronic program guide for use in conjunction with an interactive television includes a television channel and virtual channel listing. The program guide also includes an information panel that displays information that is relevant to the channels. As set forth in greater detail below, the panel represents content from at least one Web server or at least one television signal source, and it can be accessed to receive a recording request input by a user viewing the information panel to cause a recording to be made of content associated with a user-selected channel.

In yet another aspect, an interactive television includes an electronic program guide that includes a television channel listing and a Web site channel listing. The program guide also includes a record select feature to enable a user to request that content from, or associated with, a Web site be recorded.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the interactive television (ITV) system of the present invention;

FIG. 2 is a block diagram of the ITV of the present invention;

FIG. 3 is a flow chart of the overall method of the present invention;

FIG. 4 is a flow chart of the method for establishing and/or changing virtual channels;

FIG. 5 is a flow chart of the method for presenting the ITV electronic program guide;

FIG. 6 is a view of the ITV display area; and

FIG. 7 is a schematic representation of a drop-down menu useful for recording content using the program guide.

### DETAILED DESCRIPTION OF THE PREFERRED EMBODIMENTS

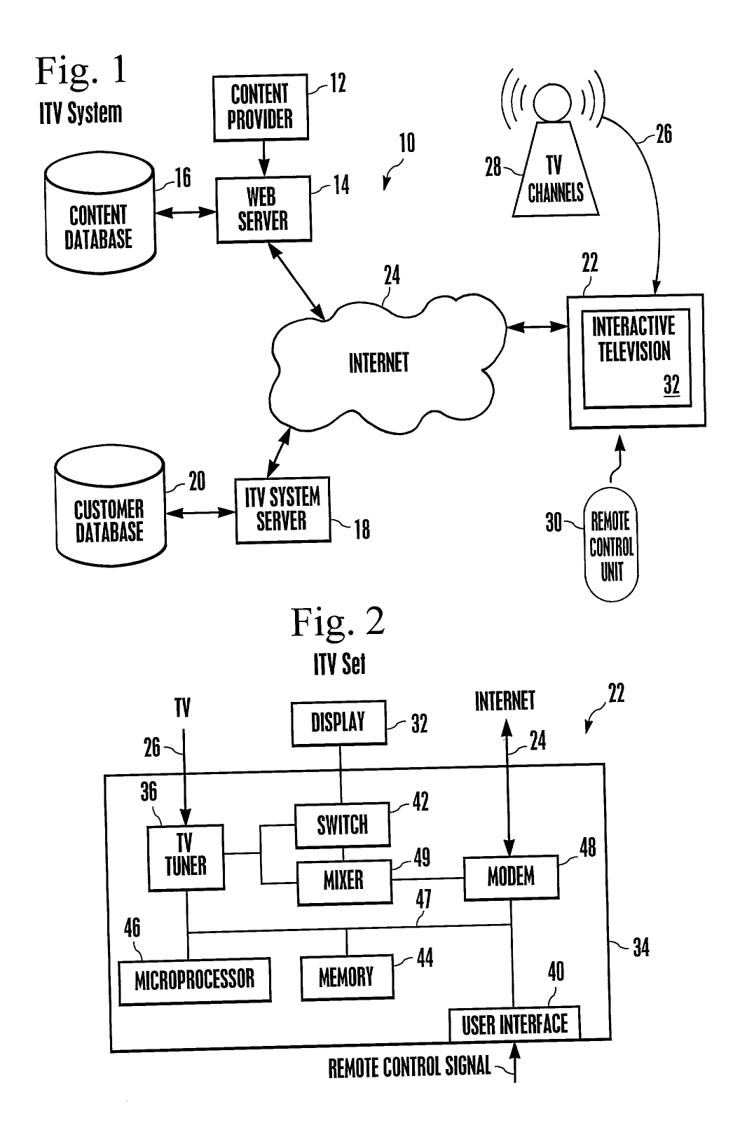

Referring initially to FIG. 1, an interactive television (ITV) system is shown, generally designated 10. As show, the system 10 includes one or more content providers 12 that provide various types of content to one or more Web servers 14 (only one content provider 12 and one Web server 14 shown for clarity of disclosure). The Web server 14 accesses a content database 16 for storage of data therein. The content on the Web server 14 can be any appropriate content, including but not limited to hypertext markup language (HTML) pages, .jpeg and .gif image files, .avi and .mpeg movie files, audio files, streaming video, and so on.

In one preferred embodiment, the system 10 also includes an ITV system server 18, which can be, e.g., a Sony Corporation Web portal. The ITV system server 18 can be a Web server computer that accesses a customer database 20. As described further below, the customer database 20 can store customer or consumer profiles that can be used to tailor virtual channels to a profile. Essentially, a virtual channel is downloaded content that is given a number, like conventional TV channels, e.g., a channel number at the end of the sequence of available TV channels. A virtual channel, once its channel number has been selected by the consumer using a TV remote control device, is displayed as a Web page or series of Web pages on the below-described ITV. In one implementation, the content of the virtual channels is stored in memory that is on board the ITV and that is periodically updated via the Internet, or the vertical blanking interval (VBI) of a conventional TV signal. In another implementation, the virtual channel content is stored remote from the ITV, e.g., at a Web server, and is streamed real-time to the ITV via a high-speed Internet access connection.

The servers 14, 18 of the present invention can be implemented by any appropriate computer, such as Internet server computers, personal computers, laptop computers, mainframe computers, and the like. The servers 14, 18 access software to execute portions of the present invention.

Plural consumer ITVs 22 (only a single ITV 22 shown for clarity) access the servers 14, 18 via the Internet 24. Also, each consumer ITV 22 receives television signals 26 from a source 28 of television signals. The source 28 can be plural broadcasters, or a cable television company, or a satellite dish, and so on. A conventional hand-held television remote control unit 30 can be manipulated by a consumer as the consumer views a display area 32 of the ITV 22 to input various selections to the ITV 22 in accordance with disclosure below. It will be appreciated that the remote control unit 30 is not a keyboard or keypad that is associated with a computer. Rather, it is a conventional remote TV control that has numeric buttons, up/down and left/right buttons, and a power button, as well as other buttons that might be conventionally provided on a TV remote control. The functions of the remote unit 30 can also be undertaken by conventional TV buttons on the ITV 22 itself. However, keyboards, keypads, motion-sensing (gesture) devices, and voice recognition input devices can also be used.

Now referring to FIG. 2, the ITV 22 is shown. While the embodiment below discusses an ITV 22 with a single housing that supports not only the display but also the microprocessor, virtual channel memory, and in general all of the electrical components shown in FIG. 2, it is to be understood that the term “interactive television” encompasses any apparatus that has a television tuner and the below-described virtual channel capability. For instance, the term “ITV” encompasses the single-housing television shown in FIG. 2, as well as a conventional television in combination with a set-top box that functions in accordance with the present invention. In the latter example, the set-top box might include, e.g., the microprocessor and memory discussed below.

As shown in FIG. 2, the ITV 22 includes a housing 34 that holds a conventional television tuner 36. The TV tuner 36 receives the TV signals 26 and outputs them to a two-position switch 38, which in turn is controlled by a user interface 40 to output a consumer-selected TV channel (in a first position) or virtual channel (in a second position) to the display 32 of the ITV 22. It is to be understood that the user interface 40 can include an infrared receiver or other receiver for sensing remote control signals from the remote control 30. Also, the user interface 40 can include a visual portion, such as but not limited to a cursor that can be moved, by means of the remote control 30, across an electronic channel guide, Web page icon, and so on that are presented on the display 32, to enable a consumer to select a channel for display.

As mentioned above, not only can a consumer select a TV channel, but a virtual channel as well. In accordance with the present invention, a “virtual channel” is not a TV channel per se, but rather a Web-based channel that can be stored in a memory or other data storage 44 in the housing 34. That is, the memory or other data storage 44 can be computer memory, or a hard disk drive, optical drive, solid state storage, tape drive, or any other suitable data storage medium.

A microprocessor 46 is also supported in the housing 34 to execute the logic steps set forth below, with the microprocessor 46, memory 44, TV tuner 36, and switch 38 all being accessible via an internal data bus 47. The microprocessor 46 assigns channel numbers to virtual channels or otherwise maintains a table of channel numbers versus TV channels and virtual channels. Accordingly, when, for instance, an electronic channel guide is displayed on the display 32 of the ITV 22, the virtual channels are listed, typically at the end of the guide after the conventional TV channels, by channel number and by name.

Alternatively, the virtual channels can be stored in a location remote from the ITV 22, e.g., they can be stored at the ITV system server 18, for display of the channels (upon consumer selection thereof) real-time via the Internet (or other network) when data transfer rates are sufficiently high to support such real-time transfer. In any case, the ITV 22 includes a modem 48 that communicates with the Internet 24. The modem 48 can be a cable modem, conventional twisted pair wire modem, DSL, wireless modem, or other appropriate communication device. It is to be understood that a single high data rate cable (e.g., either wire or optical fiber) can be provided to carry both Internet data and TV signals.

In any case, the modem 48 outputs a signal to a mixer 49, which can mix the Web-based signal from the modem 48 with related signals from the TV tuner 36. For instance, if a virtual channel of a cable newscast is selected, the Web-based content can be combined with an actual broadcast newscast from the associated news station for simultaneous display of the newscast in a window of the virtual channel. The signal from the mixer 49 is sent to the switch 42 and thence to the display 32 when the user selects a virtual channel. The mixer 49 can be established by a “Geode” chip made by National Semiconductor. As mentioned above, one or more of the microprocessor 46, memory 44, modem 48, mixer 49, and switch 42 can be housed in a set-top box that is electrically connected to a separate television housing which houses the tuner 36 and display 32.

It may now be appreciated that the microprocessor 46 controls the functions of the ITV 22 in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

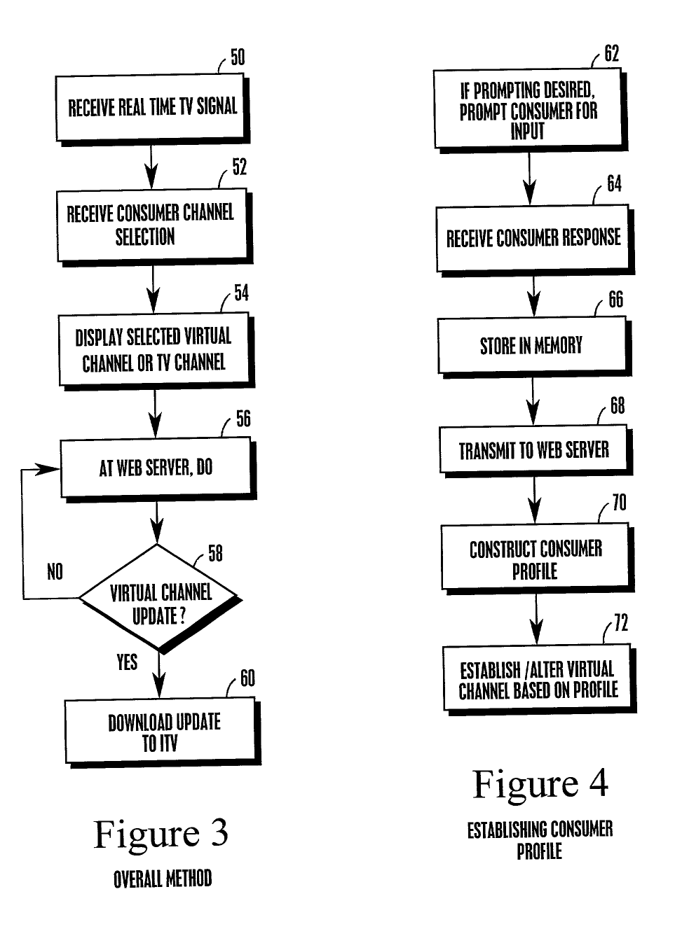

Now referring to FIG. 3, the overall logic can be seen. Commencing at block 50, real time TV signals 26 are received at the tuner 36. Assuming the ITV 22 is energized, at block 52 consumer channel selections are received by means of the user interface 40, and these channel selections are available to the microprocessor 46. Based on the selections, the microprocessor 46 causes the selected TV channel or virtual channel to be sent to the display driver 42 for display of the channel at block 54.

When a virtual channel is selected, the microprocessor 46 retrieves the associated Web page from the memory 44 for display of the channel. When the content of the virtual channel is stored at a Web server 14 that is remote from the ITV 22 (when, for instance, the ITV 22 has high speed Internet access), the microprocessor 46 retrieves the associated Web page directly from the particular server for display of the channel. Accordingly, in the preferred embodiment the ITV 22 can directly access Web servers 14 other than the ITV system server 18.

In accordance with the present invention, the virtual channels are not simply Web pages that remain static for the life of the ITV 22. Instead, they are periodically updated as the underlying Web pages on the respective Web servers 14 are updated. Accordingly, the logic moves from block 54 to block 56 wherein a DO loop is entered at either one or both of the Web server 14 and ITV system server 18. This DO loop can be entered periodically, or it can be entered in response to a user-induced or automatically induced command from the microprocessor 46, sent via the Internet 24.

At decision diamond 58, it is determined, for each virtual channel, whether an update at the corresponding Web site has occurred. The determination at decision diamond 58 can be made by the server 14/18, assuming the server knows the current content of the virtual channels of the ITV 22 (normally the case when the virtual channels are stored at a server remote from the ITV), or it can be made by the microprocessor 46 (normally the case when the virtual channels are stored in the local memory 44). For instance, the server 14/18 can send information pertaining to the update to the microprocessor 46, which can then determine whether the memory 44 stores the latest version of the virtual channel under test. If it does, the logic loops back to block 56. In the event of an update, however, the logic moves to block 60 to download the entire new Web page or pages that establish the virtual channel or, more preferably to download only the changed portions thereof.

The download can be sent via the TV signal 26 in the VBI of the signal, or it can be sent via the Internet 24 (or other network) and modem 48 (by means of a DSL or cable modem line or wireless modem line) to the memory 44. In any case, the virtual channels are periodically updated.

FIG. 4 shows the logic undertaken by the microprocessor 46 for establishing or changing what virtual channels are available to a particular ITV 22. Commencing at block 62, if it is desired to prompt the consumer for input, a prompt is displayed. The prompt can be displayed in a channel being viewed by sending the prompt through the VBI of a viewed TV channel or through the Internet when viewing a virtual channel. Alternatively, user channel selections are recorded and used in developing a user profile.

Moving to block 64, the consumer's response is received. The response is ordinarily input by means of the remote control unit 30, although other input devices as discussed above can be used. Accordingly, a prompt might ask a consumer directly what types of virtual channels are of interest. Or, it might ask about the consumer's personal preferences on a number of topics, or about the consumer's personal demographics.

In any case, the response is stored in memory at block 66. Moving to block 68, the response is transmitted to one of the servers 14, 18 (typically to the ITV system server 18). The transmission is via the Internet, and it can be undertaken sometime after the consumer input is stored, e.g., during a low-usage time period. Alternatively, when the ITV 22 is continuously in communication with the Internet, the response can be sent immediately after it is received by the microprocessor 46, without first storing it.

Then, at block 70 a consumer profile can be constructed by the server 18 based on the consumer's responses, using models known in the art to predict what types of content the consumer might desire in the virtual channels of the ITV 22. At block 72, the profile is used to establish and/or alter the virtual channels of the ITV 22 by downloading new content via the VBI or modem 48.

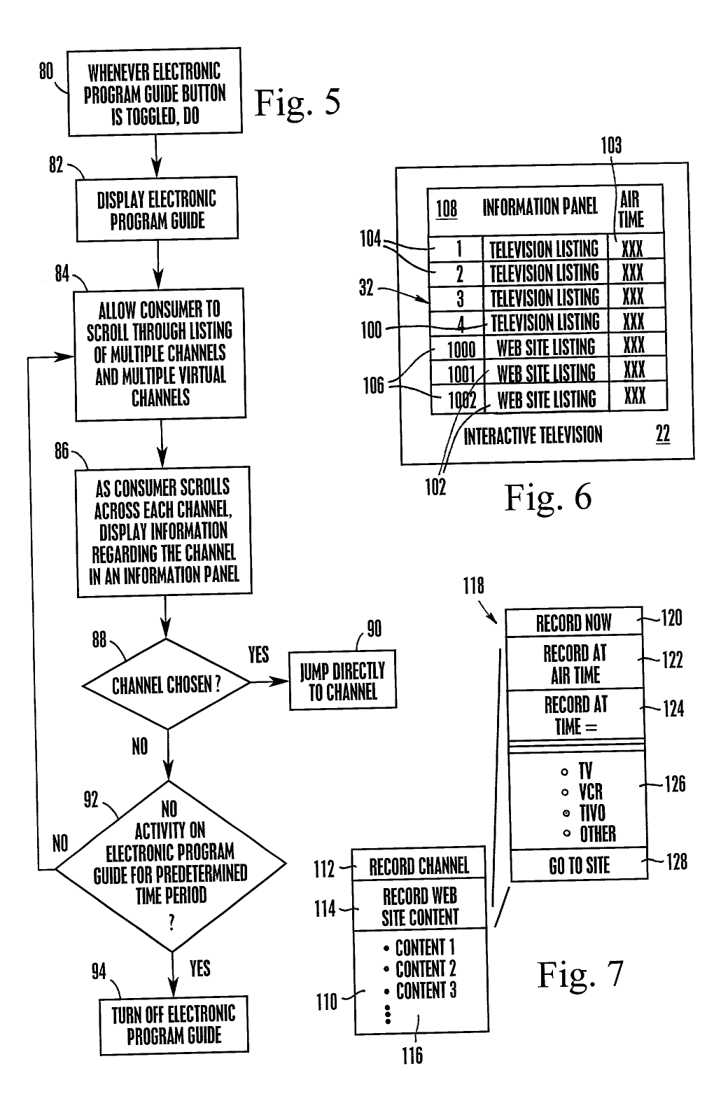

Referring to FIG. 5, the logic undertaken by the microprocessor 46 for presenting an electronic program guide is shown. Commencing at block 80, a do loop is entered wherein when an electronic program guide button is toggled, the following steps are performed. At block 82, the electronic program guide is presented to the consumer through the display 32 of the ITV 22. Moving to block 84, the consumer is allowed to scroll through a listing of multiple television channels and multiple virtual channels. It is to be understood that the consumer is able to scroll through the electronic program guide using the remote control unit 30. Moreover, as described below, the consumer is able choose a channel by scrolling to the channel and toggling a channel choose button on the remote control unit 30.

Continuing the description of the logic, at block 86, as the consumer scrolls across each channel, television or virtual, information about the content on the channel is displayed in an information panel, described below. Proceeding to decision diamond 88, it is determined whether a channel, television or virtual, is chosen. If so, the logic moves to block 90 and the ITV 22 displays the channel. If not, the logic continues to decision diamond 92, where it is determined if there has been no activity on the electronic program guide for a predetermined time period, e.g., nine seconds (9 sec). If there has been no activity for the predetermined time period, the logic moves to block 94 and the electronic program guide is turned off. If, at decision diamond 92, there is activity on the electronic program guide before the end of the predetermined time period, then the logic returns to block 84 and continues as described above.

Referring now to FIG. 6, an ITV unit, e.g., the ITV 22 described above is shown. An exemplary electronic program guide is shown in the display area 32 of the ITV 22. It is to be appreciated that the configuration of the electronic program guide shown in FIG. 6 is but one of many ways that the electronic program guide can be configured. For example, FIG. 6 shows that the electronic program guide includes multiple television channel listings 100 and multiple Web site listings 102, along with respective broadcast/air times or availability times 103. Each television channel listing 100 is linked to a respective numeric television channel indicator 104. Moreover, each Web site listing 102 is linked to a respective numeric virtual channel indicator 106.

As further shown in FIG. 6, the electronic program guide includes an information panel 108. As the consumer scrolls through the channel listings 100, 102, information about the content on the channel can be displayed in the information panel 108. It is to be appreciated that when a consumer chooses a version of the Web site stored in the ITV 22 or on the Web server 14, the system 10 hyperlinks directly to the Web site and allows the user to “surf” the Internet through the ITV 22. Essentially, a virtual channel can be a hyperlink to a locally-stored or remotely-stored version of a Web site. Thus, the need for an Internet computer is obviated.

According to the present invention, a user can also use the program guide to record both television and virtual channel content. Accordingly, referring to FIG. 7, should a user right-click over a virtual channel 106, a top level drop-down menu 110 appears on the television display. The menu 110 can include a “record channel” button 112 and a “record Web site content” button 114. When the “record Web site content” button 114 is selected, a sub-menu 116 listing content that is on the Web site available for recording, such as songs, appears. The user can then select the particular content from the sub-menu 116.

After selecting the “record channel” button 112 or selecting particular content, a lower-level menu 118 can appear. As shown in FIG. 7, the lower level menu 118 includes a “record now” button 120, which, when selected, causes the content selected in the top-level menu 110 to start being recorded. Also, the lower-level menu 118 can include a “record at air time” button 122, which, when selected, causes the content selected in the top-level menu 110 to start being recorded at the respective air time 103. It is to be understood that the “air time” can be a Webcast time. Moreover, the lower-level menu 118 can include a “record at time=” button 124, which, when selected, causes the content selected in the top-level menu 110 to start being recorded at a time that can be input by the user by appropriately manipulating the remote control unit 30.

In addition to selecting the record time, the lower-level menu 118 can also include a recording device selection list 126. The user can click on an entry in the list 126 to record the content onto the memory 44 inside the television housing, or onto a peripheral device associated with the television, such as a VCR, TiVO, or other device. In the exemplary embodiment shown, the TiVO device has been selected.

Still further, the present invention recognizes that since the virtual channels are associated with Web sites that might contain recordable content apart from whatever is being displayed on the virtual channel, the user might wish to record content as described above, but by accessing a selection feature like the menus 110, 118 that is associated with the Web site and sent to the television for use thereof by the user. To this end, the lower-level menu 118 can include a “go to site” button 128, which transports the user to the site for selection of content to be recorded. The Web site can respond by sending HTML pages to the television, with the user interacting with the pages to record the content.

While the menus 110, 118 are shown as exemplars of record select features, other implementations can use, without limitation, lists, voice recognition selectors, braille selectors, touch screen display selectors, spreadsheets, and so on.

The above principles, including use of a right-click and drop-down menus to request content recordation, can be applied to graphics user interfaces other than a television EPG. Instead, the user can use a virtual channel to request that an item of content listed on the virtual channel be recorded, either immediately or at a subsequent (e.g., broadcast) time. The content that might be listed and requested to be recorded includes audio (songs), video (game previews or movies), or content to be broadcast via the Web or via a televised broadcast at a later time. In the case where a virtual channel is associated with a television channel, and the virtual channel itself has an EPG, the EPG of the virtual channel can be used to request recordation of content by a user selecting an entry on the EPG. Or, instead of an EPG the virtual channel may use only icons or text for featured programs, and these can be selected by a user to cause the associated content to be recorded. Still further, a page in a virtual channel for a broadcast program may include link/button/icon information, allowing a user to select that link/button/icon to request recording of the associated broadcast.

While the particular ELECTRONIC PROGRAM GUIDE INCLUDING RECORDABLE VIRTUAL CHANNELS FOR INTERACTIVE TELEVISION as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A method comprising:
providing an electronic program guide on an interactive television, the guide including at least one television channel and at least one virtual channel, the virtual channel being associated with at least one Web page; and
enabling a user to access a graphics user interface associated with the ITV to record content associated with at least the virtual channel.

2. The method of claim 1, further comprising the act of:
receiving a user request to record content associated with at least one virtual channel.

3. The method of claim 2, wherein the user request is received at the television.

4. The method of claim 2, wherein the user request is received via the television and sent to a Web site associated with the virtual channel.

5. The method of claim 1, wherein the content is recorded on a medium inside the television.

6. The method of claim 1, wherein the content is recorded on a medium inside a peripheral device associated with the television.

7. The method of claim 2, wherein the user request selects a recording time listed on the program guide.

8. The method of claim 2, wherein the user request specifies a recording time not listed on the program guide.

9. The method of claim 2, wherein the user request specifies an immediate recording time.

10. The method of claim 1, wherein the graphics user interface is the program guide.

11. The method of claim 1, wherein the graphics user interface is the virtual channel.

12. The method of claim 11, wherein the graphics user interface is selected from the group including an electronic program guide of the virtual channel, icons or text for featured programs, and a page in the virtual channel for a broadcast program including link/button/icon information.

13. An electronic program guide for use in conjunction with an interactive television, comprising:
at least one television channel listing;
at least one Web site channel listing; and
an information panel, the information panel displaying information relevant to plural channels, the panel representing content from at least one Web server and at least one television signal source, the program guide being accessible to receive a recording request input by a user viewing the program guide to cause a recording to be made of content associated with a user-selected channel.

14. An interactive television, comprising:
an electronic program guide displayed by the interactive television, the electronic program guide having:
at least one television channel listing;
at least one Web site channel listing; and
at least one record select feature displayable on the television to enable a user to request that content from at least one Web site be recorded.

15. The interactive television of claim 14, wherein the record select feature includes at least one pop-up menu.

16. The interactive television of claim 14, further comprising an electronic program guide button, the electronic program guide being displayed when the electronic program guide button is toggled.

17. The interactive television of claim 16, further comprising a remote control unit, the remote control unit having the electronic program guide button.

18. The interactive television of claim 14, wherein the electronic program guide further comprises at least one virtual channel indicator, the virtual channel indicator being associated with a respective Web site listing.

19. The interactive television of claim 18, wherein a consumer can open communications with a Web site represented by a Web site listing by selecting the corresponding virtual channel indicator.

20. The interactive television of claim 14, wherein the electronic program guide further comprises:
an information panel, the information panel displaying information relevant to a channel on the program guide.

21. The interactive television of claim 20, wherein the electronic program guide includes content from at least one Web server.

22. The interactive television of claim 21, wherein the electronic program guide further includes content from at least one television signal source.

23. The interactive television of claim 22, wherein the electronic program guide further includes content from at least one interactive television system server.

24. The interactive television of claim 14, wherein the record select feature is the program guide.

25. The interactive television of claim 14, wherein the record select feature is the virtual channel.

26. The interactive television of claim 25, wherein the record select feature is selected from the group including an electronic program guide of the virtual channel, icons or text for featured programs, and a page in the virtual channel for a broadcast program including link/button/icon information.

27. A method comprising:
providing an electronic program guide on an interactive television having at least a virtual channel and a television channel, the guide including at least one listed television channel, the listed television channel being associated with at least one Web page; and
enabling a user to access a graphics user interface associated with the ITV to record content associated with at least the virtual channel or the broadcast channel.
